(19) United States
(12) Patent Application Publication
(10) Pub. No.: US 2017/0090474 A1
(43) Pub. Date: Mar. 30, 2017

(54) Drone Safety Mechanism

(71) Applicants: Vincent Paul Spinella-Mamo, Boca Raton, FL (US); Alan Keith Hopkins, Mays Landing, NJ (US)

(72) Inventors: Vincent Paul Spinella-Mamo, Boca Raton, FL (US); Alan Keith Hopkins, Mays Landing, NJ (US)

(21) Appl. No.: 15/278,197

(22) Filed: Sep. 28, 2016

Related U.S. Application Data
(60) Provisional application No. 62/234,358, filed on Sep. 29, 2015.

(51) Int. Cl. G05D 1/00; G08G 5/00; G05D 1/04; H04B 7/185; B64C 39/02; B64D 45/00

(52) U.S. Cl. CPC G05D 1/0055; B64C 39/024; B64D 45/00; G05D 1/0088; G05D 1/0011; G05D 1/042; H04B 7/18506; G08G 5/0013; G08G 5/0008; B64C 2201/141; B64C 2201/146

(57) ABSTRACT

A drone safety mechanism that prevents autonomously controlled or human-in-the-loop drones from interfering with aircraft. A signal is generated at the center of an area to be maintained free of drone activity. The signal decays with distance from the source of the signal. A sensor onboard the drone is able to measure the signal itself, as well as the strength of the signal. When the signal strength passes above some threshold level, or the signal provides some other message, an intention is sent to the drone that forces the drone to stop and/or descend. The signal may be a preexisting signal, such as an electromagnetic signal emitted from a radar system atop an air traffic control tower. To prevent drones interfering with aircraft in flight, the signal may be emitted from the aircraft itself.

### CROSS REFERENCE TO RELATED APPLICATIONS

This application claims the benefit of the filing date under 35 USC 119(e) of the provisional application entitled “Drone Safety Mechanism” Ser. No. 62/234,358, filed on Sep. 29, 2015, the entire contents of which is fully incorporated herein by reference.

### BACKGROUND OF THE INVENTION

The present invention provides a system for providing drone safety. Drones are remote controlled or autonomous systems. These drones can have the form of aircraft, land based vehicles, or watercraft.

The continuously decreasing cost of these drones, specifically aerial drones, has dramatically increased commercial drone activity. This increase has created a serious impact on air traffic. Specifically, aerial drones have interfered with aircraft while in flight, and has the potential to create massive fatalities. The risk to aircraft is especially high at, and near, takeoff and landing of the aircraft. Detecting these drones has also been a problem because of their small size. The inability to detect these drones has led to an inability to maintain airfields free of aerial drone activity through various mechanisms.

### BRIEF DESCRIPTION OF THE DRAWINGS

FIG. 1 presents detailed element diagram illustrating use of electromagnetic signals to prevent commercial drones from approaching airports.

FIG. 2 presents a detailed element diagram illustrating electromagnetic signals generated from an aircraft to prevent commercial drones from interfering.

FIG. 3 represents a diagram for setting a threshold value.

FIG. 4 illustrates an example computer system.

Like reference numerals refer to like parts throughout the various views of the drawings.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The following detailed description is directed to limiting drones in various air spaces. As above, drone flights near occupied airspace creates dangerous situations, such as drones interfering with commercial air transport. Current solutions require active tracking of airspace environments using various techniques, such as through the use of computer vision. These techniques require large amounts of computational resources, sensors, and tracking capabilities. Additionally, such solutions require destruction of the drones identified.

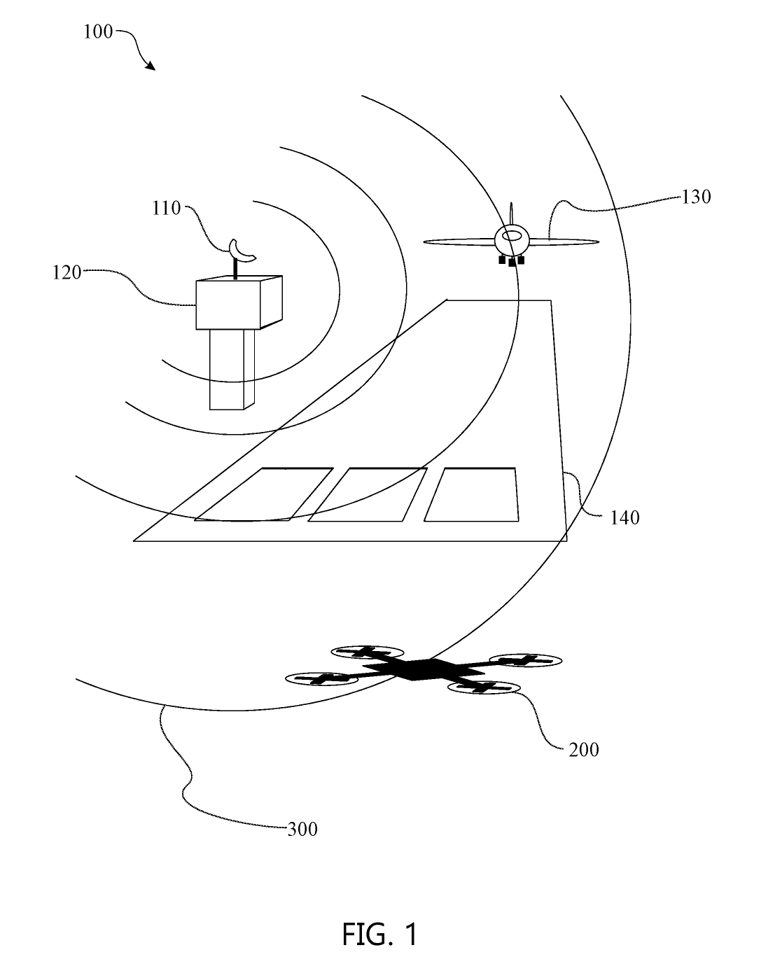

Many of these air spaces, however, already emanate electromagnetic signals. For instance, many airports constantly use some form of radar to monitor the airspace. The power level of the signal can be directly converted to a distance, as will be discussed in detail below. By incorporating a sensor onboard these drone systems to sense these electromagnetic signals, a stop or descend command is then sent once a certain threshold signal level is detected. This single sensor solution greatly reduces the amount of computation necessary to protect airspaces from drones. More details are provided below with reference to FIGS. 1-4.

FIG. 1 illustrates a drone safety system 100. In one embodiment, the drone safety system 100 as shown in FIG. 1 depicts an aircraft 130 approaching an airfield 140. Specifically, the aircraft 130 is depicted approaching an airfield 140 to land. Though depicted in FIG. 1 for exemplary purposes, the aircraft 130 may also be taking-off from, or otherwise departing, the airfield 140. A control tower 120 is depicted in FIG. 1, which is in communication with the aircraft 130. The control tower 120 constantly monitors for all aircraft that are landing, or taking off from, the airfield 140. In order to monitor all aircraft activity, the control tower 120 is equipped with a radar system 110. The radar system 110 emits electromagnetic signals 300 to detect all aircraft activity. Typically, the radar system 110 emits electromagnetic signals 300 in a range of 2.3-2.7 GHz, though other frequencies are contemplated. The radar system 110 may optionally limit transmission of the electromagnetic signals 300 to a particular field of view and perform rotations at a certain rate in order to cover a desired area. As an example, the radar system 110 may cover a field of view of 20 degrees at a rotation rate of one revolution every five seconds. The geographical extent of a transmission of an electromagnetic signal 300 from the radar system 110 is limited by the amount of power used to drive the radar system 110. For example, the electromagnetic signals 300 are emitted from the radar system 110 at a power strong enough to be detected with commercial off the shelf (COTS) sensors as far away as 20,000 feet. Though use of the radar system 110 is described, other transmission mechanisms, such as audial and visual transmissions, are contemplated. For exemplary purposes, if the radar system 110 were to transmit audio signals at a specific frequency, Fourier analysis can be performed on a signal from a microphone aboard the drone 200 to determine if a Fourier power of a microphone signal at a given frequency is above some threshold value. The audio frequency may be subsonic, sonic, or ultrasonic. In addition, these transmissions may be emitted from points of origin other than the radar system 110.

In general, the amount of power per unit area of the electromagnetic signals 300 transmitted by the radar system 110 diminishes in accordance with an inverse square law. What this means is that a power per unit area measured 10 meters from the source is 100 times less than the power per unit area measured 1 meter from the source of an electromagnetic signal 300. A drone 200 is also depicted in FIG. 1. The drone 200 is equipped with an antenna, or other sensor, which is able to sense the electromagnetic signals 300, or other signals, emitted in accordance with the drone safety system 100. The sensor on board the drone 200 is able to determine an amount of power per unit area of the electromagnetic signals 300. A threshold value can be set by using the inverse square law in conjunction with an area of the sensor, an emitted power, and desired distance to maintain free of drones 200. For example, if a 1000 m perimeter were desired around a radar system 110, emitting at a power of 10⁷ W and is detected by a sensor having an area of 0.1 m², the threshold value, T, would be set as follows:

$$T = \frac{{P}_{system} A}{4 π {r}^{2}} = \frac{{10}^{7} W * 0.1 {m}^{2}}{4 π * {10}^{6} {m}^{2}} = 0.08 W$$

If the sensor detects more than 0.08 W of power at a frequency equal to that of the electromagnetic signals 300 emitted by the radar system 110, a safety signal is sent to a processor aboard the drone 200. The safety signal overrides any previously provided commands, whether via a remote operator or programmed, and forces the drone 200 to immediately stop. Alternatively, the safety signal may also force the drone 200 to descend so that it may be recovered by an operator.

Optionally, the electromagnetic signals 300 may act as a carrier signal for a drone specific message. Instead of checking a measured value of power against a threshold value, the sensor aboard the drone 200 constantly monitors for the drone specific message. For instance, the drone specific message may be the existence of any power at a specific frequency. Alternatively, the electromagnetic signals 300 may act as a carrier signal and be modulated to carry an input signal. A sensor aboard the drone 200 extracts the input signal from the carrier signal. For example, the input signal may be extracted using a demodulator. The input signal may be digital or analog and is sent directly to a processor aboard the drone 200 as the safety signal. The input signal overrides any other signal sent to the processor aboard the drone 200 and instructs the drone 200 to stop and may instruct the drone 200 to descend.

In an alternative embodiment, the electromagnetic signals 300 received at the drone 200 at a drone antenna can be determined using a signal to noise ratio of the electromagnetic signals 300, where the signal to noise ratio (SNR) is determined as:

$$SNR = \frac{{P}_{T} {G}_{T} {G}_{R} {λ}^{2} σ}{{( 4 π )}^{3} {R}^{4} {kT}_{0} {BF}_{N} L}$$

Here P_{T} is the peak transmit power, G_{T} and G_{R} are gains associated with the transmit and receive antennae, respectively, λ, is the wavelength of the radar, sigma is the radar cross sectional area, R is the range from the drone 200 to the radar, T₀ the reference temperature in Kelvin (generally 290K), k Boltzman's constant, B is the effective noise bandwidth, F_{N} is the noise figure, and L all losses that should be considered. For example, L could be those related to the radar itself, the environment in which the radar operates, et cetera. Both gains may be calculated as geometric gains based on the shape of the antenna and the method in which the radar signal is propagated from the antenna. Here, if a signal to noise ratio is calculated as being higher than some threshold level, or contains some carried signal specific to the drone, the drone 200 is instructed to stop and descend.

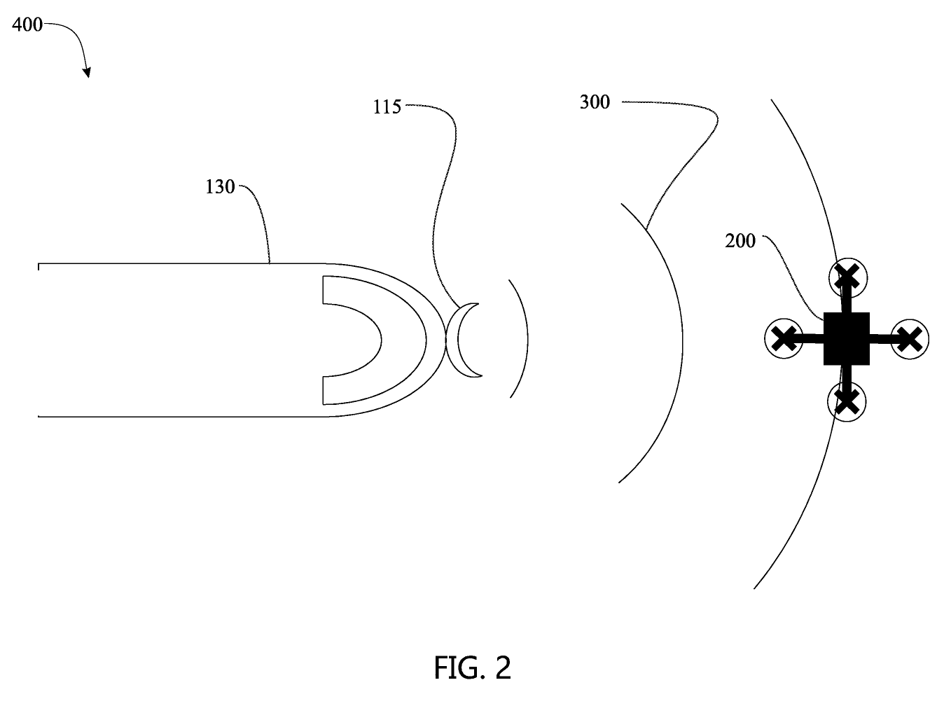

Turning now to FIG. 2, an aircraft-specific drone safety system 400 can be installed directly on any other device, such as aircraft 130. As another example, the drone safety system 400 can be installed on other drones to facilitate communication between drones in highly crowded drone airspaces. Similar to the radar system 110, a transmitter 115 may be directly coupled to the aircraft 130. The transmitter 115 is capable of emitting electromagnetic signals 300. In many instances, the aircraft is already equipped with a device that may act as the transmitter 115. Typically, the transmitter 115 emits electromagnetic signals 300 in a range of 2.3-2.7 GHz, though other frequencies are contemplated. The transmitter 115 may optionally limit transmission of the electromagnetic signals 300 to a particular field of view and perform rotations at a certain rate in order to cover a desired area of coverage. For exemplary purposes, the transmitter 115 may cover a field of view of 20 degrees at a rotation rate of one revolution every five seconds. The geographical extent of a transmission of an electromagnetic signal 300 from the transmitter 115 is limited by the amount of power used to drive the transmitter 115. For exemplary purposes, the electromagnetic signals 300 are emitted from the transmitter 115 at a power strong enough to be detected with commercial off the shelf (COTS) sensors as far away as 20,000 feet (6,096 meters). Though use of the transmitter 115 emitting electromagnetic signals 300 is described, other transmission mechanisms, such as audial and visual transmissions, are contemplated. For exemplary purposes, if the transmitter 115 were to transmit audio signals at a specific frequency, Fourier analysis can be performed on a signal from a microphone aboard the drone 200 to determine if a Fourier power of a microphone signal at a given frequency is above some threshold value. The audio frequency may be subsonic, sonic, or ultrasonic.

In general, the amount of power per unit area of the electromagnetic signal 300 transmitted by the transmitter 115 diminishes in accordance with an inverse square law. What this means is that a power per unit area measured 10 meters from the source is 100 times less than the power per unit area measured 1 meter from the source of an electromagnetic signal 300. A drone 200 is also depicted in FIG. 2. The drone 200 is equipped with an antenna, or other sensor, which is able to sense the electromagnetic signals 300, or other signals, emitted in accordance with the drone safety system 400. The sensor on board the drone 200 is able to determine an amount of power per unit area of the electromagnetic signals 300. A threshold value can be set by using the inverse square law in conjunction with an area of the sensor, an emitted power, and desired distance to maintain free of drones 200. For example, if a 1000 m perimeter were desired around a transmitter 115, emitting at a power of 10⁷ W and is detected by a sensor having an area of 0.1 m², the threshold value, T, would be set as follows:

$$T = \frac{{P}_{system} A}{4 π {r}^{2}} = \frac{{10}^{7} W * 0.1 {m}^{2}}{4 π * {10}^{6} {m}^{2}} = 0.08 W$$

If the sensor detects more than 0.08 W of power at a frequency equal to that of the electromagnetic signals 300 emitted by the transmitter 115, a safety signal is sent to a processor aboard the drone 200. The safety signal overrides any previously provided commands, whether via a remote operator or programmed, and forces the drone 200 to immediately stop. Alternatively, the safety signal may also force the drone 200 to descend so that it may be recovered by an operator.

Optionally, the electromagnetic signals 300 may act as a carrier signal for a drone specific message. Instead of checking a measured value of power against a threshold value, the sensor aboard the drone 200 constantly monitors for the drone specific message. For instance, the drone specific message may be the existence of any power at a specific frequency. Alternatively, the electromagnetic signals 300 may act as a carrier signal and be modulated to carry an input signal. A sensor aboard the drone 200 extracts the input signal from the carrier signal. For example, the input signal may be extracted using a demodulator. The input signal may be digital or analog and is sent directly to a processor aboard the drone 200 as the safety signal. The safety signal overrides any other signal sent to the processor aboard the drone 200 and instructs the drone 200 to stop and may instruct the drone 200 to descend.

Additionally, the aircraft 130 may be equipped with multiple transmitters 115, so as to emit the safety signal in all directions.

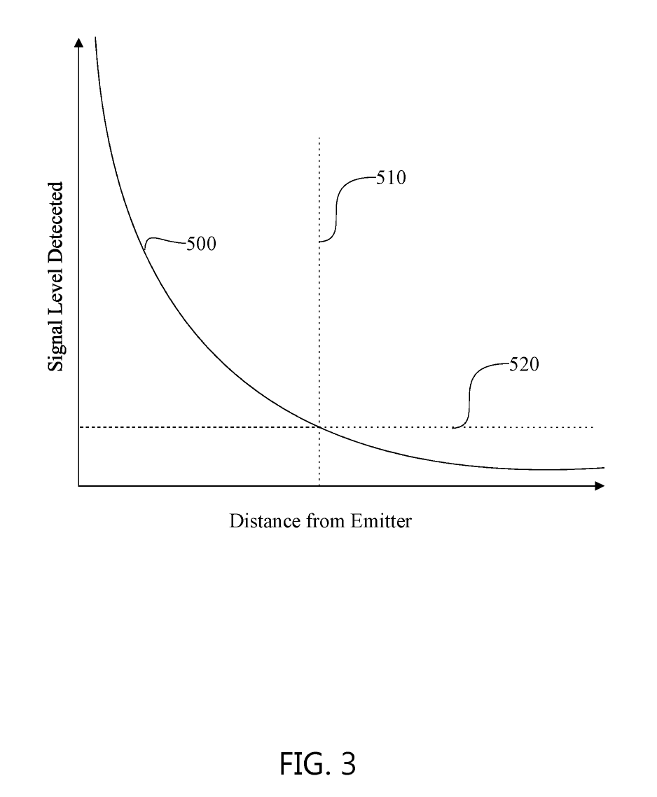

FIG. 3 illustrates a threshold as described in either of FIG. 1 or 2. As described, a signal level 500, such as a power level, decays inversely with the square of distance. A user may select a safe distance 510 from which drones may safely operate. By selecting a safe distance 510, a threshold level 520 may be calculated. This threshold level 520 is what may be used in the drone safety mechanism in any of the embodiments above.

### The Computerized System

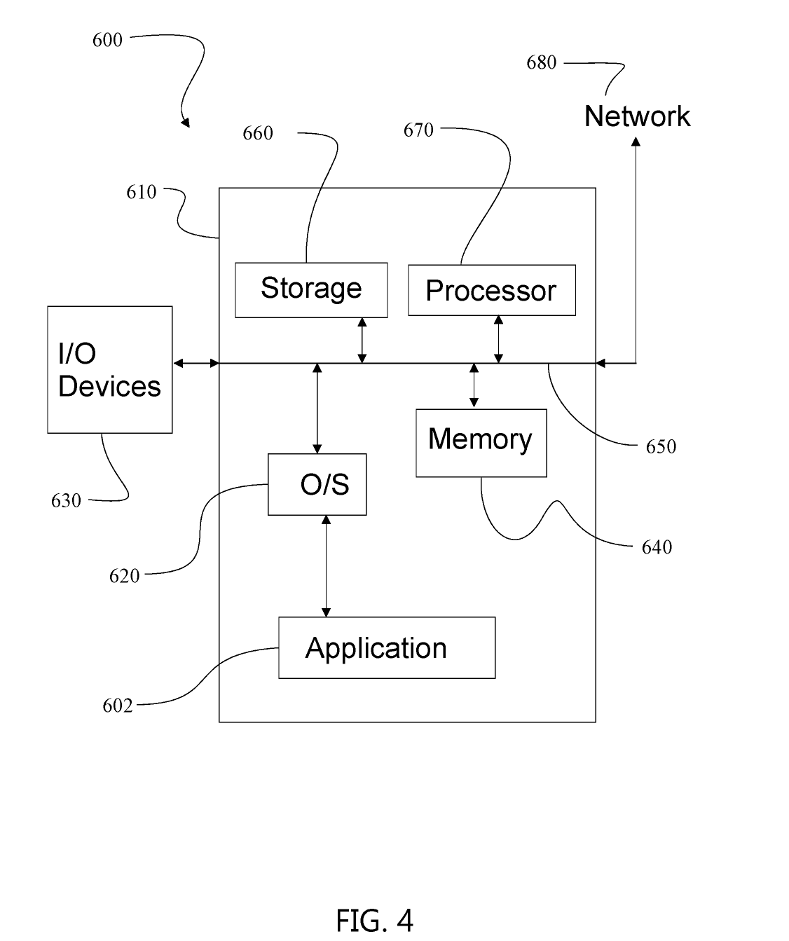

Turning briefly to FIG. 4, a computerized system 600 is depicted as an example computerized system on which the invention may be implemented. The computerized system 600 depicts a computer system 610 that comprises a storage 660, a processor 670, a memory 640, and an operating system 620. The storage 660, processor 670, memory 640, and operating system 620 may be communicatively coupled over a communication infrastructure 650. Optionally, the computer system 610 may interact with a user via I/O devices 630, as well as a network 680, via the communication infrastructure 650. The operating system 620 may interact with other components to control application 602.

The systems and methods described herein can be implemented in software or hardware or any combination thereof. The systems and methods described herein can be implemented using one or more computing devices which may or may not be physically or logically separate from each other. The methods may be performed by components arranged as either on-premise hardware, on-premise virtual systems, or hosted-private instances. Additionally, various aspects of the methods described herein may be combined or merged into other functions.

An example computerized system for implementing the invention is illustrated in FIG. 4. A processor or computer system can be configured to particularly perform some or all of the method described herein. In some embodiments, the method can be partially or fully automated by one or more computers or processors. The invention may be implemented using a combination of any of hardware, firmware and/or software. The present invention (or any part(s) or function(s) thereof) may be implemented using hardware, software, firmware, or a combination thereof and may be implemented in one or more computer systems or other processing systems. In some embodiments, the illustrated system elements could be combined into a single hardware device or separated into multiple hardware devices. If multiple hardware devices are used, the hardware devices could be physically located proximate to or remotely from each other. The embodiments of the methods described and illustrated are intended to be illustrative and not to be limiting. For example, some or all of the steps of the methods can be combined, rearranged, and/or omitted in different embodiments.

In one exemplary embodiment, the invention may be directed toward one or more computer systems capable of carrying out the functionality described herein. Example computing devices may be, but are not limited to, a personal computer (PC) system running any operating system such as, but not limited to, Microsoft™ Windows™. However, the invention may not be limited to these platforms. Instead, the invention may be implemented on any appropriate computer system running any appropriate operating system. Other components of the invention, such as, but not limited to, a computing device, a communications device, mobile phone, a telephony device, a telephone, a personal digital assistant (PDA), a personal computer (PC), a handheld PC, an interactive television (iTV), a digital video recorder (DVD), client workstations, thin clients, thick clients, proxy servers, network communication servers, remote access devices, client computers, server computers, routers, web servers, data, media, audio, video, telephony or streaming technology servers, etc., may also be implemented using a computing device. Services may be provided on demand using, e.g., but not limited to, an interactive television (iTV), a video on demand system (VOD), and via a digital video recorder (DVR), or other on demand viewing system.

The system may include one or more processors. The processor(s) may be connected to a communication infrastructure, such as but not limited to, a communications bus, cross-over bar, or network, etc. The processes and processors need not be located at the same physical locations. In other words, processes can be executed at one or more geographically distant processors, over for example, a LAN or WAN connection. Computing devices may include a display interface that may forward graphics, text, and other data from the communication infrastructure for display on a display unit.

The computer system may also include, but is not limited to, a main memory, random access memory (RAM), and a secondary memory, etc. The secondary memory may include, for example, a hard disk drive and/or a removable storage drive, such as a compact disk drive CD-ROM, etc. The removable storage drive may read from and/or write to a removable storage unit. As may be appreciated, the removable storage unit may include a computer usable storage medium having stored therein computer software and/or data. In some embodiments, a machine-accessible medium may refer to any storage device used for storing data accessible by a computer. Examples of a machine-accessible medium may include, e.g., but not limited to: a magnetic hard disk; a floppy disk; an optical disk, like a compact disk read-only memory (CD-ROM) or a digital versatile disk (DVD); a magnetic tape; and/or a memory chip, etc.

The processor may also include, or be operatively coupled to communicate with, one or more data storage devices for storing data. Such data storage devices can include, as non-limiting examples, magnetic disks (including internal hard disks and removable disks), magneto-optical disks, optical disks, read-only memory, random access memory, and/or flash storage. Storage devices suitable for tangibly embodying computer program instructions and data can also include all forms of non-volatile memory, including, for example, semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

The processing system can be in communication with a computerized data storage system. The data storage system can include a non-relational or relational data store, such as a MySQL™ or other relational database. Other physical and logical database types could be used. The data store may be a database server, such as Microsoft SQL Server™, Oracle™, IBM DB2™, SQLITE™, or any other database software, relational or otherwise. The data store may store the information identifying syntactical tags and any information required to operate on syntactical tags. In some embodiments, the processing system may use object-oriented programming and may store data in objects. In these embodiments, the processing system may use an object-relational mapper (ORM) to store the data objects in a relational database. The systems and methods described herein can be implemented using any number of physical data models. In one example embodiment, an RDBMS can be used. In those embodiments, tables in the RDBMS can include columns that represent coordinates. In the case of economic systems, data representing companies, products, etc. can be stored in tables in the RDBMS. The tables can have pre-defined relationships between them. The tables can also have adjuncts associated with the coordinates.

In alternative exemplary embodiments, secondary memory may include other similar devices for allowing computer programs or other instructions to be loaded into computer system. Such devices may include, for example, a removable storage unit and an interface. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units and interfaces, which may allow software and data to be transferred from the removable storage unit to computer system.

The computing device may also include an input device such as but not limited to, a mouse or other pointing device such as a digitizer, and a keyboard or other data entry device (not shown). The computing device may also include output devices, such as but not limited to, a display, and a display interface. Computer may include input/output (I/O) devices such as but not limited to a communications interface, cable and communications path, etc. These devices may include, but are not limited to, a network interface card, and modems. Communications interface may allow software and data to be transferred between computer system and external devices.

In one or more embodiments, the present embodiments are practiced in the environment of a computer network or networks. The network can include a private network, or a public network (for example the Internet, as described below), or a combination of both. The network includes hardware, software, or a combination of both.

From a telecommunications-oriented view, the network can be described as a set of hardware nodes interconnected by a communications facility, with one or more processes (hardware, software, or a combination thereof) functioning at each such node. The processes can inter-communicate and exchange information with one another via communication pathways between them using interprocess communication pathways. On these pathways, appropriate communications protocols are used.

An exemplary computer and/or telecommunications network environment in accordance with the present embodiments may include node, which include may hardware, software, or a combination of hardware and software. The nodes may be interconnected via a communications network. Each node may include one or more processes, executable by processors incorporated into the nodes. A single process may be run by multiple processors, or multiple processes may be run by a single processor, for example. Additionally, each of the nodes may provide an interface point between network and the outside world, and may incorporate a collection of sub-networks.

In an exemplary embodiment, the processes may communicate with one another through interprocess communication pathways supporting communication through any communications protocol. The pathways may function in sequence or in parallel, continuously or intermittently. The pathways can use any of the communications standards, protocols or technologies, described herein with respect to a communications network, in addition to standard parallel instruction sets used by many computers.

The nodes may include any entities capable of performing processing functions. Examples of such nodes that can be used with the embodiments include computers (such as personal computers, workstations, servers, or mainframes), handheld wireless devices and wireline devices (such as personal digital assistants (PDAs), modem cell phones with processing capability, wireless email devices including BlackBerry™ devices), document processing devices (such as scanners, printers, facsimile machines, or multifunction document machines), or complex entities (such as local-area networks or wide area networks) to which are connected a collection of processors, as described. For example, in the context of the present invention, a node itself can be a wide-area network (WAN), a local-area network (LAN), a private network (such as a Virtual Private Network (VPN)), or collection of networks.

Communications between the nodes may be made possible by a communications network. A node may be connected either continuously or intermittently with communications network. As an example, in the context of the present invention, a communications network can be a digital communications infrastructure providing adequate bandwidth and information security.

The communications network can include wireline communications capability, wireless communications capability, or a combination of both, at any frequencies, using any type of standard, protocol or technology. In addition, in the present embodiments, the communications network can be a private network (for example, a VPN) or a public network (for example, the Internet).

A non-inclusive list of exemplary wireless protocols and technologies used by a communications network may include BlueTooth™, general packet radio service (GPRS), cellular digital packet data (CDPD), mobile solutions platform (MSP), multimedia messaging (MMS), wireless application protocol (WAP), code division multiple access (CDMA), short message service (SMS), wireless markup language (WML), handheld device markup language (HDML), binary runtime environment for wireless (BREW), radio access network (RAN), and packet switched core networks (PS-CN). Also included are various generation wireless technologies. An exemplary non-inclusive list of primarily wireline protocols and technologies used by a communications network includes asynchronous transfer mode (ATM), enhanced interior gateway routing protocol (EIGRP), frame relay (FR), high-level data link control (HDLC), Internet control message protocol (ICMP), interior gateway routing protocol (IGRP), internetwork packet exchange (IPX), ISDN, point-to-point protocol (PPP), transmission control protocol/internet protocol (TCP/IP), routing information protocol (RIP) and user datagram protocol (UDP). As skilled persons will recognize, any other known or anticipated wireless or wireline protocols and technologies can be used.

Embodiments of the present invention may include apparatuses for performing the operations herein. An apparatus may be specially constructed for the desired purposes, or it may comprise a general purpose device selectively activated or reconfigured by a program stored in the device.

In one or more embodiments, the present embodiments are embodied in machine-executable instructions. The instructions can be used to cause a processing device, for example a general-purpose or special-purpose processor, which is programmed with the instructions, to perform the steps of the present invention. Alternatively, the steps of the present invention can be performed by specific hardware components that contain hardwired logic for performing the steps, or by any combination of programmed computer components and custom hardware components. For example, the present invention can be provided as a computer program product, as outlined above. In this environment, the embodiments can include a machine-readable medium having instructions stored on it. The instructions can be used to program any processor or processors (or other electronic devices) to perform a process or method according to the present exemplary embodiments. In addition, the present invention can also be downloaded and stored on a computer program product. Here, the program can be transferred from a remote computer (e.g., a server) to a requesting computer (e.g., a client) by way of data signals embodied in a carrier wave or other propagation medium via a communication link (e.g., a modem or network connection) and ultimately such signals may be stored on the computer systems for subsequent execution).

The methods can be implemented in a computer program product accessible from a computer-usable or computer-readable storage medium that provides program code for use by or in connection with a computer or any instruction execution system. A computer-usable or computer-readable storage medium can be any apparatus that can contain or store the program for use by or in connection with the computer or instruction execution system, apparatus, or device.

A data processing system suitable for storing and/or executing the corresponding program code can include at least one processor coupled directly or indirectly to computerized data storage devices such as memory elements. Input/output (I/O) devices (including but not limited to keyboards, displays, pointing devices, etc.) can be coupled to the system. Network adapters may also be coupled to the system to enable the data processing system to become coupled to other data processing systems or remote printers or storage devices through intervening private or public networks. To provide for interaction with a user, the features can be implemented on a computer with a display device, such as an LCD (liquid crystal display), or another type of monitor for displaying information to the user, and a keyboard and an input device, such as a mouse or trackball by which the user can provide input to the computer.

A computer program can be a set of instructions that can be used, directly or indirectly, in a computer. The systems and methods described herein can be implemented using programming languages such as Flash™, JAVA™, C++, C, C#, Python, Visual Basic™ JavaScript™ PHP, XML, HTML, etc., or a combination of programming languages, including compiled or interpreted languages, and can be deployed in any form, including as a stand-alone program or as a module, component, subroutine, or other unit suitable for use in a computing environment. The software can include, but is not limited to, firmware, resident software, microcode, etc. Protocols such as SOAP/HTTP may be used in implementing interfaces between programming modules. The components and functionality described herein may be implemented on any desktop operating system executing in a virtualized or non-virtualized environment, using any programming language suitable for software development, including, but not limited to, different versions of Microsoft Windows™, Apple™ Mac™, iOS™, Unix™/X-Windows™, Linux™, etc. The system could be implemented using a web application framework, such as Ruby on Rails.

Suitable processors for the execution of a program of instructions include, but are not limited to, general and special purpose microprocessors, and the sole processor or one of multiple processors or cores, of any kind of computer. A processor may receive and store instructions and data from a computerized data storage device such as a read-only memory, a random access memory, both, or any combination of the data storage devices described herein. A processor may include any processing circuitry or control circuitry operative to control the operations and performance of an electronic device.

The systems, modules, and methods described herein can be implemented using any combination of software or hardware elements. The systems, modules, and methods described herein can be implemented using one or more virtual machines operating alone or in combination with one other. Any applicable virtualization solution can be used for encapsulating a physical computing machine platform into a virtual machine that is executed under the control of virtualization software running on a hardware computing platform or host. The virtual machine can have both virtual system hardware and guest operating system software.

The systems and methods described herein can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks that form the Internet.

One or more embodiments of the invention may be practiced with other computer system configurations, including hand-held devices, microprocessor systems, microprocessor-based or programmable consumer electronics, minicomputers, mainframe computers, etc. The invention may also be practiced in distributed computing environments where tasks are performed by remote processing devices that are linked through a network.

The terms “computer program medium” and “computer readable medium” may be used to generally refer to media such as but not limited to removable storage drive, a hard disk installed in hard disk drive. These computer program products may provide software to computer system. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the description and claims, the terms “coupled” and “connected,” along with their derivatives, may be used. It should be understood that these terms may be not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm may be here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, it may be appreciated that throughout the specification terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. The terms “system” and “method” are used herein interchangeably insofar as the system may embody one or more methods and the methods may be considered as a system.

While one or more embodiments of the invention have been described, various alterations, additions, permutations and equivalents thereof are included within the scope of the invention.

In the description of embodiments, reference is made to the accompanying drawings that form a part hereof, which show by way of illustration specific embodiments of the claimed subject matter. It is to be understood that other embodiments may be used and that changes or alterations, such as structural changes, may be made. Such embodiments, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other embodiments using alternative orderings of the computations could be readily implemented. In addition to being reordered, the computations could also be decomposed into sub-computations with the same results.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What we claim is:

1. A system for performing a drone safety mechanism including a non-transitory computer readable medium containing instructions that, when executed by one or more processors, cause the one or more processors to:
receive sensor data from at least one sensor positioned on a drone;
determine, based at least in part on the sensor data, a safety signal; and
relay the safety signal to a processor onboard the drone.

2. The system of claim 1, wherein the at least one sensor is an electromagnetic signal sensor.

3. The system of claim 2, wherein the safety signal is generated when an output of the electromagnetic signal sensor surpasses a threshold.

4. The system of claim 3, wherein the electromagnetic signal sensor outputs sensor data in response to an electromagnetic signal having a frequency of between 2.3 and 2.7 GHz.

5. The system of claim 3, wherein the threshold value, T, is mathematically related to a distance, r, power of an emitter, P, and cross sectional area of the at least one sensor, A, as T=(P*A)/(4π²r²).

6. The system of claim 3, wherein the threshold value is met when a signal to noise ratio of the sensor data is exceeded.

7. The system of claim 3, wherein the safety signal is one of a stop signal or a descent signal.

8. The system of claim 1, wherein the sensor data is demodulated to recover a safety signal and further wherein the demodulated signal contains a drone command.

9. The system of claim 1, wherein the sensor is an audio sensor.

10. The system of claim 4, wherein the electromagnetic signal is emitted by a radar of an air traffic control tower.

11. The system of claim 4, wherein the electromagnetic signal is emitted by an aircraft.

12. A method for performing a drone safety comprising performing the following operations:
receiving sensor data from at least one sensor positioned on a drone;
determining, based at least in part on the sensor data, a safety signal; and
relaying the safety signal to a processor onboard the drone,
wherein the at least one sensor is an electromagnetic signal sensor, and
further wherein the sensor data is generated in response to an electromagnetic signal, the electromagnetic signal being generated by a radar of an air traffic control tower.

13. The method of claim 12, wherein the electromagnetic signal has a frequency between 2.3 GHz and 2.7 GHz.

14. The method of claim 12, wherein the safety signal is generated when the sensor data surpasses a threshold.

15. The method of claim 14, wherein the threshold is mathematically related to a distance, r, power of the radar, P, and cross sectional area of the at least one sensor, A, as T=(P*A)/(4π²r²).

16. The method of claim 12, wherein the safety signal is generated when the sensor data surpasses a signal to noise ratio.

17. The method of claim 12, wherein the sensor data is demodulated to create the safety signal, the safety signal comprising a command to issue to the processor.

18. The method of claim 17, wherein the drone command is at least one of stop or descend.

19. The method of claim 15, wherein the safety signal is at least one of a stop command or a descend command.

20. A non-transitory computer readable medium containing instructions that, when executed by one or more processors, cause the one or more processors to:
receive sensor data from at least one sensor positioned on a drone,
wherein the sensor data is generated in response to an electromagnetic signal emitted from a radar of an air traffic control tower;
determine, based at least in part on the sensor data, a safety signal,
wherein the safety signal is generated when the sensor data surpasses a threshold and comprises at least one of a stop command and a descend command; and
relay the safety signal to a processor onboard the drone to execute the safety signal.
